(19) United States
(12) Patent Application Publication
(10) Pub. No.: US 2014/0160270 A1
(43) Pub. Date: Jun. 12, 2014

(54) CORRECTION APPARATUS, PROBE APPARATUS, AND TEST APPARATUS

(71) Applicant: Advantest Corporation, Tokyo (JP)

(72) Inventors: Takashi NAITO, Gunma (JP); Atsushi HAYAKAWA, Saitama (JP)

(73) Assignee: ADVANTEST CORPORATION, Tokyo (JP)

(21) Appl. No.: 14/059,422

(22) Filed: Oct. 21, 2013

(30) Foreign Application Priority Data
Dec. 6, 2012 (JP) 2012-267590

(51) Int. Cl. G01B 11/14

(52) U.S. Cl. CPC G01B 11/14
USPC 348/87; 348/95

(57) ABSTRACT

In order to decrease the time needed to correct misalignment when holding an object with positional accuracy and transport the object, provided is a correction apparatus that corrects misalignment of a transported object at a transport destination, comprising a first sensor that is secured to a transporting section transporting the object; and a correction control section that detects a first offset between the transporting section and the first sensor, while the object transported to the transport destination is positioned at the transport destination, by using the first sensor to detect a position of a first reference point provided to correspond to a target position at the transport destination. Also provided is a probe apparatus and a test apparatus.

### BACKGROUND

1. Technical Field

The present invention relates to a correction apparatus, a probe apparatus, and a test apparatus.

2. Related Art

A conventional apparatus is known that includes a transporting section for transporting a target object and securing the object at a fixed position at the transport destination. For example, a test apparatus is known that mounts a device under test on a tray, transports the device under test mounted on the tray to a test head, secures the device under test to the test head, and tests the device under test, such as shown in Patent Document 1.
Patent Document 1: Japanese Patent Application Publication No. 2010-204096

In order to improve the positioning accuracy, when mounting the device under test on the tray and securing the tray to the test head, this apparatus corrects the misalignment of each component. It is preferable that the testing time for this apparatus not be affected even when such a correction is performed each time a device under test is transported.

### SUMMARY

Therefore, it is an object of an aspect of the innovations herein to provide a correction apparatus, a probe apparatus, and a test apparatus, which are capable of overcoming the above drawbacks accompanying the related art. The above and other objects can be achieved by combinations described in the claims. According to a first aspect of the present invention, provided is a correction apparatus that corrects misalignment of a transported object at a transport destination, comprising a first sensor that is secured to a transporting section transporting the object; and a correction control section that detects a first offset between the transporting section and the first sensor, while the object transported to the transport destination is positioned at the transport destination, by using the first sensor to detect a position of a first reference point provided to correspond to a target position at the transport destination. Also provided is a probe apparatus and a test apparatus.

The summary clause does not necessarily describe all necessary features of the embodiments of the present invention. The present invention may also be a sub-combination of the features described above.

### BRIEF DESCRIPTION OF THE DRAWINGS

FIG. 1 is a front view of the entirety of a test apparatus 100 according to the present embodiment.

FIG. 2 is a partial cross-sectional view of the test apparatus 100 according to the present embodiment.

FIG. 3 is a partial horizontal cross-sectional view of the test apparatus 100 according to the present embodiment.

FIG. 4 is a partial vertical cross-sectional view of the correction apparatus 400 according to the present embodiment.

FIG. 5 shows a process flow of the correction apparatus 400 according to the present embodiment.

FIG. 6 is a partial vertical cross-sectional view of a stage at which the correction control section 500 according to the present embodiment detects the second offset.

FIG. 7 is a partial vertical cross-sectional view of a stage at which the correction control section 500 according to the present invention detects the first offset and performs calibration.

FIG. 8 is a partial vertical cross-sectional view of a stage at which the first sensors 430a and 430b according to the present embodiment detect the corresponding first reference points 460a.

FIG. 9 is a partial vertical cross-sectional view of a stage at which the holding section 424a according to the present embodiment holds the semiconductor wafer 101a together with the wafer tray 450a.

FIG. 10 is a partial vertical cross-sectional view of a stage at which the correction control section 500 according to the present embodiment detects the first offset during testing of the semiconductor wafer 101a.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

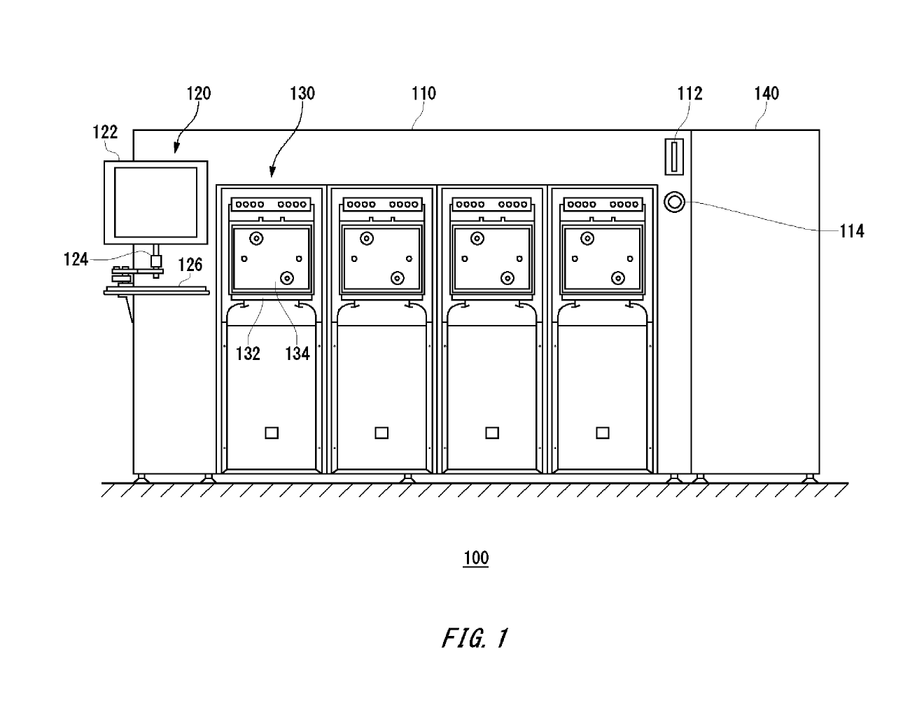

FIG. 1 is a front view of the entirety of a test apparatus 100 according to the present embodiment. The test apparatus 100 transports a wafer having a plurality of devices under test formed thereon within the apparatus, corrects misalignment of the semiconductor wafer, brings the semiconductor wafer into contact with a contact destination at a suitable location, and tests the devices under test.

The test apparatus 100 tests devices under test such as analog circuits, digital circuits, memories, and systems on chips (SOC). The test apparatus 100 inputs to each device under test a test signal based on a test pattern for testing the device under test, and judges pass/fail of the device under test based on an output signal output by the device under test in response to the test signal. The test apparatus 100 includes an EFEM 110, a manipulating section 120, a load unit 130, and a cooler 140.

The EFEM 110 (Equipment Front End Module) houses a mechanism that transports a substrate serving as the test target within the test apparatus 100. In the test apparatus 100, the EFEM 110 has the largest dimensions, and therefore the signal lamp 112 that indicates the operational state of the test apparatus 100 and an EMO 114 (EMergency OFF) that operates when the test apparatus 100 is to be suddenly stopped are arranged at positions high on the front surface of the EFEM 110.

The manipulating section 120 is also supported by the EFEM 110. The manipulating section 120 includes a display 122, an arm 124, and an input apparatus 126. One end of the arm 124 is connected to the EFEM 110 and the other end supports the display 122 and the input apparatus 126 in a freely movable manner.

The display 122 may include a liquid crystal display apparatus, for example, that displays the operational state of the test apparatus 100 or echo back of the input content from the input apparatus 126, for example. The input apparatus 126 may include a keyboard, mouse, tracking ball, and/or jog dial, for example, and receives settings or manipulations of the test apparatus 100, for example.

The load unit 130 includes a load table 132 and a load gate 134. The load table 132 has a container housing the semiconductor wafer serving as the test target mounted thereon. The load gate 134 opens and closes when the semiconductor wafer is transported into or out of the test apparatus 100. In this way, the semiconductor wafer can be loaded from the outside without reducing the cleanliness within the test apparatus 100.

The cooler 140 heats and supplies a heating medium that circulates within the test apparatus 100, when heating the temperature around the wafer to a target temperature during testing by the test apparatus 100, for example. The cooler 140 supplies a cooled cooling medium when cooling the wafer before transport that has become heated by the testing operation in the test apparatus 100. Therefore, the cooler 140 includes a heat exchanger and is arranged near the test head that performs testing. The cooler 140 may be omitted from the test apparatus 100 if a source supplying the heated or cooled thermal medium is provided separately outside of the test apparatus 100.

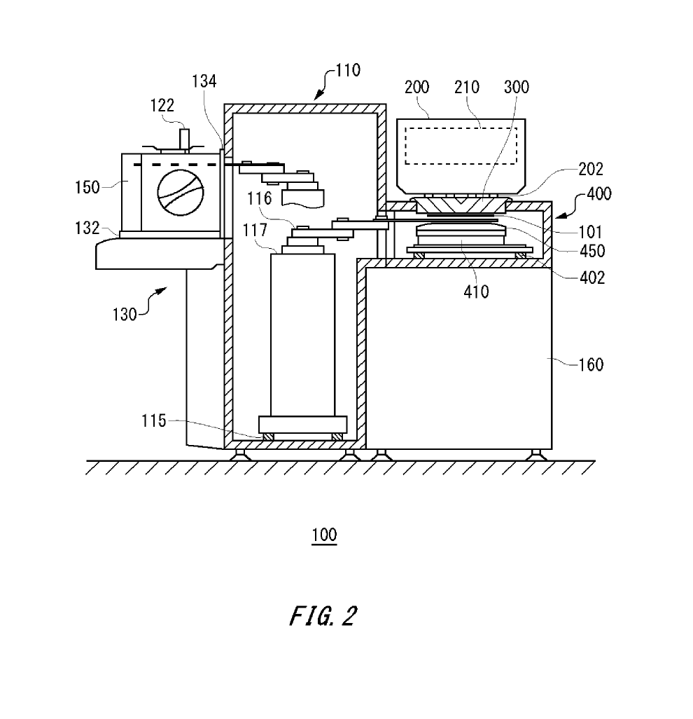

FIG. 2 is a partial cross-sectional view of the test apparatus 100 according to the present embodiment. In FIG. 2, components identical to those in FIG. 1 are given the same reference numerals and redundant descriptions are omitted. The test apparatus 100 includes a load unit 130, an EFEM 110, a main frame 160, an correction apparatus 400, a probe card 300, and a test head 200. FIG. 2 omits the cooler 140 from view.

In the test apparatus 100, the load unit 130, the EFEM 110, and the main frame 160 are arranged adjacently in the stated order from front (the left side in FIG. 2) to back (the right side in FIG. 2). Furthermore, the correction apparatus 400, the probe card 300, and the test head 200 are stacked on the main frame 160, for example.

A FOUP 150 (Front Opening Unified Pod) is mounted on the load table 132 of the load unit 130. The FOUP 150 stores a plurality of semiconductor wafers 101 to serve as test targets. Semiconductor wafers are also stored in the FOUP 150 when recycling the semiconductor wafers 101 after testing is finished.

The EFEM 110 houses the robot arm 116. The robot arm 116 is mounted on a column 117 that runs along a rail 115, and transports the semiconductor wafer 101 between the load unit 130 and the correction apparatus 400. Therefore, the load unit 130 and the EFEM 110 have an air-tight connection and the correction apparatus 400 and the EFEM 110 have an air-tight connection, thereby maintaining high cleanliness within these regions.

The main frame 160 controls the overall operation of the test apparatus 100. For example, the main frame 160 is connected to the test head 200, the probe card 300, and the correction apparatus 400, and performs testing while synchronizing each component. Furthermore, the main frame 160 is connected to the manipulating section 120, receives input from the input apparatus 126, and reflects this input in each component of the test apparatus 100. The main frame 160 generates display content that reflects the operational state of the test apparatus 100, and displays this content in the display 122.

The main frame 160 synchronizes operation of the load unit 130, the EFEM 110, and the correction apparatus 400, to pass the semiconductor wafer 101 between these sections. Furthermore, when the EMO 114 is manipulated, the main frame 160 immediately stops the operation of each component of the test apparatus 100.

The correction apparatus 400 transports a target object and corrects misalignment of the transport destination. The correction apparatus 400 transports a plurality of target objects to each of a plurality of transport destinations. Here, the target objects may be semiconductor substrates, glass substrates, or semiconductor devices formed as chips, for example. The target objects are transported by a transport apparatus such as a stage or robot, and may be substrates, devices, components, apparatuses, or chasses held at a predetermined position at the transport destination.

The present embodiment describes a semiconductor wafer 101 and a wafer tray 450, as an example of target objects. The misalignment correction operation performed by the correction apparatus 400 is described further below. The correction apparatus 400 includes an alignment stage 410.

The alignment stage 410 has the wafer tray 450 and the semiconductor wafer 101 mounted thereon, and runs along the rail 402. The alignment stage 410 moves vertically, and can raise and lower the semiconductor wafer 101 mounted thereon. In this way, after the semiconductor wafer 101 has been aligned with the probe card 300, the wafer 101 is pressed against the probe card 300 positioned thereabove.

The probe card 300 is electrically connected to a plurality of electrodes formed on the semiconductor wafer 101. When the test apparatus 100 performs testing, the semiconductor wafer 101 and the test head 200 are electrically connected with the probe card 300 interposed therebetween. In this way, an electrical signal path is created between the test head 200 and the semiconductor wafer 101.

Here, the probe card 300 includes probes that correspond to the arrangement of the electrodes formed on the semiconductor wafer 101 and connect electrically to these electrodes. In other words, the test apparatus 100 can be made to correspond to semiconductor wafers 101 with different layouts by exchanging the probe card 300.

The test head 200 stores a plurality of pin electronics 210. The pin electronics 210 include electrical circuits that correspond to the content of the testing and the target of the testing. The test head 200 is electrically connected to the probe card 300 via contactors attached to the bottom surface of the test head 200. The semiconductor wafer 101 is electrically connected to the pin electronics 210 to exchange electrical signals with the pin electronics 210.

The test apparatus 100 described above has the load table 132 mounted thereon with the semiconductor wafer 101 to be tested housed in the FOUP 150. The robot arm 116 takes one semiconductor wafer 101 at a time through the load gate 134 and transports the semiconductor wafer 101 to the correction apparatus 400.

In the correction apparatus 400, the wafer 101 is mounted on a wafer tray 450 on the alignment stage 410. After the mounted wafer 101 is aligned with the probe card 300, the alignment stage 410 presses the probe card 300 from above.

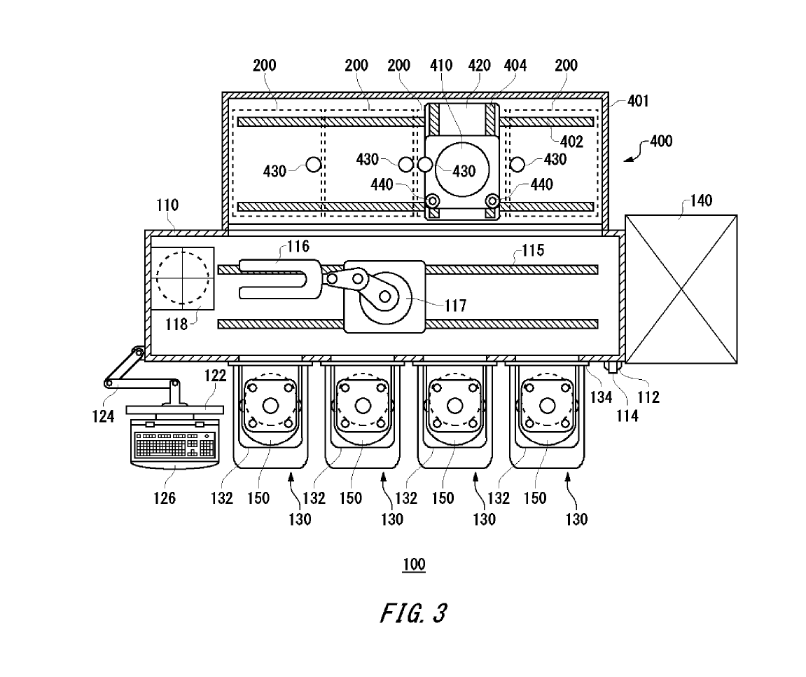

FIG. 3 is a partial horizontal cross-sectional view of the test apparatus 100 according to the present embodiment. In FIG. 3, components identical to those in FIG. 1 or 2 are given the same reference numerals and redundant descriptions are omitted. The test apparatus 100 includes four load units 130 and four test heads 200. Furthermore, each load unit 130 includes a FOUP 150.

One EFEM 110 and one correction apparatus 400 are provided. The correction apparatus 400 includes a single alignment stage 410.

In the EFEM 110, the column 117 supporting the robot arm 116 moves along the rail 115 over substantially all of the width of the EFEM 110. Accordingly, the robot arm 116 can transport the semiconductor wafer 101 to any of the four load units 130 and four test heads.

A pre-aligner 118 is arranged in the EFEM 110 at the end opposite the cooler 140, for example. The pre-aligner 118 adjusts the mounting position of the semiconductor wafer 101 relative to the robot arm 116, with a predetermined accuracy. For example, the pre-aligner 118 performs the adjustment with an accuracy that is less than the accuracy of the positioning of the test head 200.

In this way, the initial positioning accuracy when the robot arm 116 mounts the semiconductor wafer 101 on the wafer tray 450 is improved, and the time needed to align the semiconductor wafer 101 with the probe card 300 is reduced. Furthermore, the throughput of the test apparatus 100 is improved.

As described above, the test apparatus 100 of the present embodiment transports the semiconductor wafers 101 stored in the FOUP 150 one at a time to the correction apparatus 400, using the robot arm 116. The test apparatus 100 positions the semiconductor wafer 101 in the correction apparatus 400, presses the semiconductor wafer 101 against the probe card 300, and holds the semiconductor wafer 101 in electrical contact with the probe card 300.

The test apparatus 100 separates a semiconductor wafer 101 for which testing is completed from the probe card 300, and transports the semiconductor wafer 101 from the correction apparatus 400 to the FOUP 150. The test apparatus 100 repeats the operation described above, thereby sequentially testing the semiconductor wafers 101 stored in the FOUP 150.

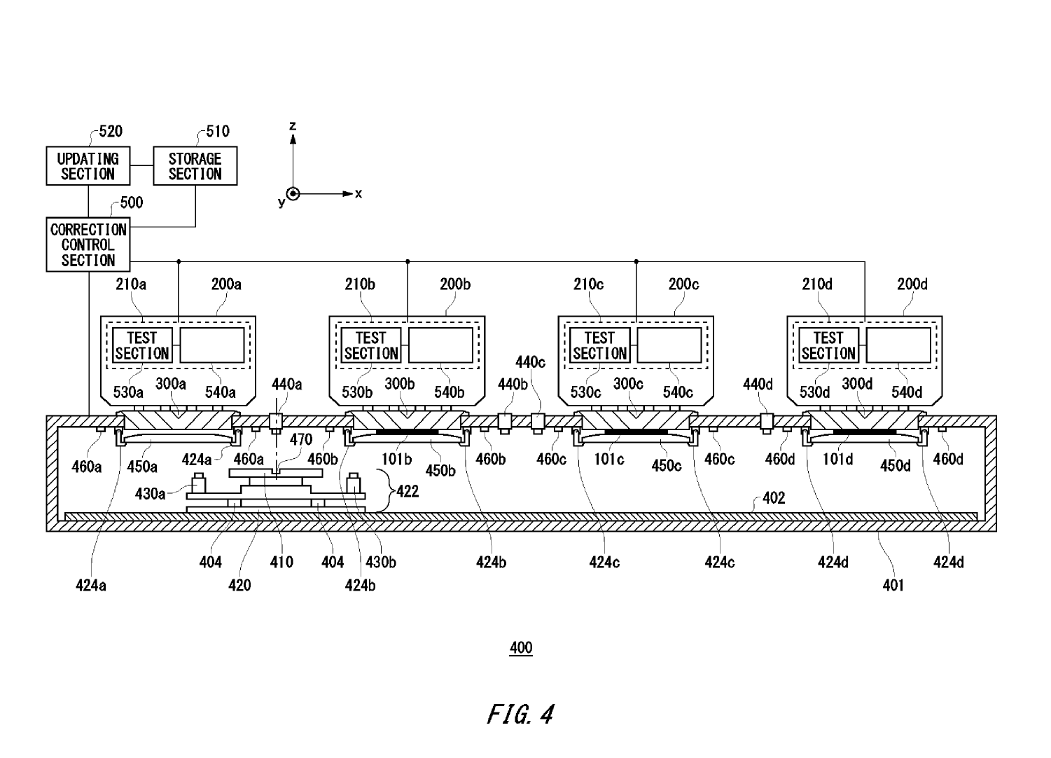

The test apparatus 100 holds a semiconductor wafer 101 for each probe card 300 of the test head 200, for example, and exchanges electrical signals with the semiconductor wafers 101 to perform testing. In the present embodiment, the test apparatus 100 holds a maximum of four semiconductor wafers 101 on four probe cards 300 corresponding to four test heads 200. The devices formed on each of the four semiconductor wafers 101 are respectively tested. The operation of the correction apparatus 400 according to the present embodiment is described below with reference to FIGS. 3 and 4.

FIG. 4 is a partial vertical cross-sectional view of the correction apparatus 400 according to the present embodiment. The correction apparatus 400 includes a case 401, a rail 402, a transporting section 422, holding sections 424, first sensors 430, second sensors 440, first reference points 460, a second reference point 470, a correction control section 500, a storage section 510, an updating section 520, a test section 530, and a transmitting section 540.

The rail 402 is arranged to span the entire width of the case 401 along the bottom surface thereof. The rail 402 may be arranged along the x-axis direction shown in FIG. 4. The transporting section 422 has a wafer tray 450 holding the semiconductor wafer 101 mounted thereon, and transports a semiconductor wafer 101 together with each wafer tray 450. The transporting section 422 includes an alignment stage 410 and a stage carrier 420.

The stage carrier 420 moves along the rail 402 in the longitudinal direction of the case 401. The stage carrier 420 includes, on the top surface thereof, a rail 404 that runs orthogonal to the rail 402 of the case 401. In other words, the rail 404 is arranged along the y-axis direction in FIG. 4, for example.

The alignment stage 410 moves in the direction of the shorter dimension of the case 401 on the rail 404. The alignment stage 410 includes a z-axis stage and moves in a vertical direction that is substantially parallel to the z-axis direction.

The holding sections 424 are provided to correspond to the probe cards 300 in the case 401, and hold the wafer trays 450. When the test apparatus 100 tests a semiconductor wafer 101, the holding sections 424 hold the wafer tray 450 on which this semiconductor wafer 101 is mounted.

In the present embodiment, the four holding sections 424a to 424d are provided to correspond to four probe cards 300a to 300d, and respectively hold the four corresponding wafer trays 450a to 450d. The four wafer trays 450a to 450d respectively have four semiconductor wafers 101a to 101d, which correspond to the four probe cards 300a to 300d, mounted thereon.

The first sensors 430 are provided on the transporting section 422, are secured to the transporting section 422 that transports the wafer tray 450 having the semiconductor wafer 101 mounted thereon, and detect the positions of first reference points 460 provided at positions corresponding to target positions serving as transport destination. In the present embodiment, the transport destination is a wafer station including a holding section 424 and a probe card 300. Furthermore, the target position for the transport destination is a probe card 300. In other words, the transporting section 422 transports a wafer tray 450 with a semiconductor wafer 101 mounted thereon to a probe card 300 of a wafer station.

The first reference points 460 are provided on the ceiling surface of the case 401 near a corresponding probe card 300, and face the first sensors 430. The first reference points 460 are provided at predetermined positions, and may be marks or the like having a predetermined shape. Instead, the first reference points 460 may be protrusions or recesses having a predetermined shape.

The first sensors 430 detect the positions of the first reference points 460, thereby aligning a semiconductor wafer 101 and a probe card 300. In other words, first reference points 460 are arranged such that the semiconductor wafer 101 and the probe card 300 are aligned when the first sensors 430 detect the first reference points 460.

In this way, the electrodes formed on the semiconductor wafer 101 can be electrically connected to the probes corresponding to these electrodes formed on the probe card 300. Furthermore, the holding sections 424 hold a wafer tray 450, and secure the wafer tray 450 in alignment with the semiconductor wafer 101 and the probe card 300.

A plurality of the first sensors 430 are provided on the transporting section 422, for example. In the present embodiment, the first sensors 430a and 430b are provided on the transporting section 422, and respectively detect the positions of each of the first reference points 460a to 460d corresponding respectively to the probe cards 300a to 300d. The first sensors 430 may be provided on the transporting section 422 facing a direction that is substantially parallel to the z-axis direction.

The first sensors 430 include a first image capturing section that captures images of the first reference points 460, for example. In the present embodiment, the first sensors 430 are a plurality of probe cameras that detect the position of each first reference point 460 provided corresponding to the respective probe cards 300. In other words, the first sensors 430 capture images of regions that include the first reference points 460 near the probe cards 300, and detect these first reference points 460.

The second sensors 440 are secured at predetermined positions relative to the first reference points 460. The second sensors 440 each detect a second offset between the semiconductor wafer 101 and a position of a second reference point 470 provided on one surface of the transporting section 422, when the semiconductor wafer 101 is mounted on the one surface of the transporting section 422 from the outside. Each second sensor 440 detects the second offset by detecting a predetermined reference point of the semiconductor wafer 101 and a position of the second reference point 470. Here, the predetermined reference point of the semiconductor wafer 101 may be a pattern formed on the semiconductor wafer 101, or may be an edge portion of the semiconductor wafer 101.

The second sensors 440 correspond respectively to the probe cards 300, and are provided near the probe cards 300. For example, the second sensors 440 may be provided on the ceiling surface of the case 401 and face downward in a direction substantially parallel to the z-axis.

A plurality of the second sensors 440 may be provided on the case 401, for example. In the present embodiment, the second sensors 440a to 440d are provided to correspond respectively to the probe cards 300a to 300d, and each detect the position of the second reference point 470.

The second reference point 470 is provided on the center of the top surface of the alignment stage 410, for example, in a manner to face the second sensors 440. The second reference point 470 is provided at a predetermined position and may be a mark having a predetermined shape, or a protrusion or recess having a predetermined shape. In the present embodiment, the second reference point 470 is a recess formed substantially in the center of the stage surface of the alignment stage 410.

The second sensors 440 may include second image capturing sections, for example. In the present embodiment, the second sensors 440 are wafer cameras that detect the position of each semiconductor wafer 101 and the position of the second reference point 470.

The correction control section 500 is connected to the first sensors 430 and uses the first sensors 430 to detect the positions of the first reference points 460. The correction control section 500 detects a first offset between the transporting section 422 and the first sensors 430, while positioning the wafer tray 450 with one semiconductor wafer 101 mounted thereon, which has been transported to a probe card 300, at the probe card 300.

The correction control section 500 may detect the first offset by detecting the positions of a second sensor 440 with a first sensor 430. In other words, the correction control section 500 detects the first offset between the transporting section 422 and the first sensor 430 based on the position of the second sensor 440 detected by the first sensor 430. Instead, the correction control section 500 may detect the first offset by detecting the position of the first sensor 430 with the second sensor 440.

In other words, the first offset may be detected by having the second sensor 440 detect the position of the first sensor 430 and the position of the second reference point 470 secured on the transporting section 422. In this case, the second sensor 440 detects the positions of one or more of the probe cameras to detect the first offset and the second offset.

The correction control section 500 corrects the misalignment with a wafer station based on detection results for the position of the first reference point 460 obtained using the first sensor 430, in response to the change in the first offset detected by the first sensor 430 exceeding a reference change amount. The reference change amount may be a predetermined change amount of the first offset. The correction control section 500 is electrically connected to the transporting section 422, the first sensor 430, the second sensor 440, the wafer station, and the like, and controls the correction operation of the correction apparatus 400.

The storage section 510 stores the first offset between the transporting section 422 and the first sensor 430. The storage section 510 may store a reference point position of the semiconductor wafer 101, a reference change amount, the second offset, and the like.

When the change of the first offset detected by the correction control section 500 exceeds the reference change amount, the updating section 520 updates the first offset stored in the storage section 510 to be the first offset detected by the correction control section 500. In this way, the updating section 520 sequentially updates the first offset according to the correction of the misalignment in the wafer station by the correction apparatus 400. The correction control section 500 detects the change in the first offset based on the updated first offset.

The test section 530 is provided in the pin electronics 210, and exchanges electrical signals with the devices under test formed on the semiconductor wafer 101 to test these devices under test. The test section 530 inputs to each device under test a test signal based on a test pattern for testing the device under test. The test section 530 judges pass/fail of each device under test based on an output signal that is output by the device under test in response to the test signal.

The transmitting section 540 is connected to the test section 530 and transmits a start signal that causes the correction control section 500 to begin detecting the first offset. The transmitting section 540 transmits the start signal before the testing is completed for all of the one or more devices under test formed on a single semiconductor wafer. For example, the transmitting section 540 may transmit the start signal to the correction control section 500, and the correction control section 500 may begin detecting the first offset in response to receiving the start signal.

The correction apparatus 400 described above can align the semiconductor wafer 101 on the alignment stage 410 with a probe card 300, by using the first sensor 430 and the second sensor 440. In other words, when the semiconductor wafer 101 is mounted on the alignment stage 410, the position of the semiconductor wafer 101 is determined with a pre-alignment accuracy. Then, by detecting the edge, for example, of the semiconductor wafer 101 using the second sensor 440 facing downward, the position of the semiconductor wafer 101 on the alignment stage 410 can be accurately detected.

On the other hand, the relative position of the second sensor 440 provided in the case 401 relative to the probe card 300 is already known. Therefore, the difference between the position of the semiconductor wafer 101 and the position of the probe card 300 can be detected. Accordingly, the alignment stage 410 can be moved in a manner to compensate for this difference, thereby aligning the semiconductor wafer 101 and the probe card 300 by using the first sensor 430.

In this way, the correction apparatus 400 uses the first sensor 430 and the second sensor 440 to align the semiconductor wafer 101 and the probe card 300, and transports the semiconductor wafer 101. As a result, the correction apparatus 400 can correct the misalignment occurring due to change over time of the mechanical components and/or change in internal temperature, for example. However, when the correction apparatus 400 performs this correction every time a semiconductor wafer 101 is transported, the amount of time needed for the correction is added to the testing time of the test apparatus 100.

Therefore, the correction apparatus 400 of the present embodiment corrects the misalignment when the amount of misalignment is greater than or equal to a predetermined amount, due to a variety of causes such as change over time of the mechanical components and/or change in internal temperature. The correction apparatus 400 determines whether misalignment occurs during testing of the semiconductor wafer 101, and therefore can shorten the overall testing time. Furthermore, the correction apparatus 400 does not perform the correction operation if misalignment requiring correction has not occurred. As a result, the increase of testing time when no misalignment occurs can be avoided. The following describes the flow of the correction performed by the correction apparatus 400.

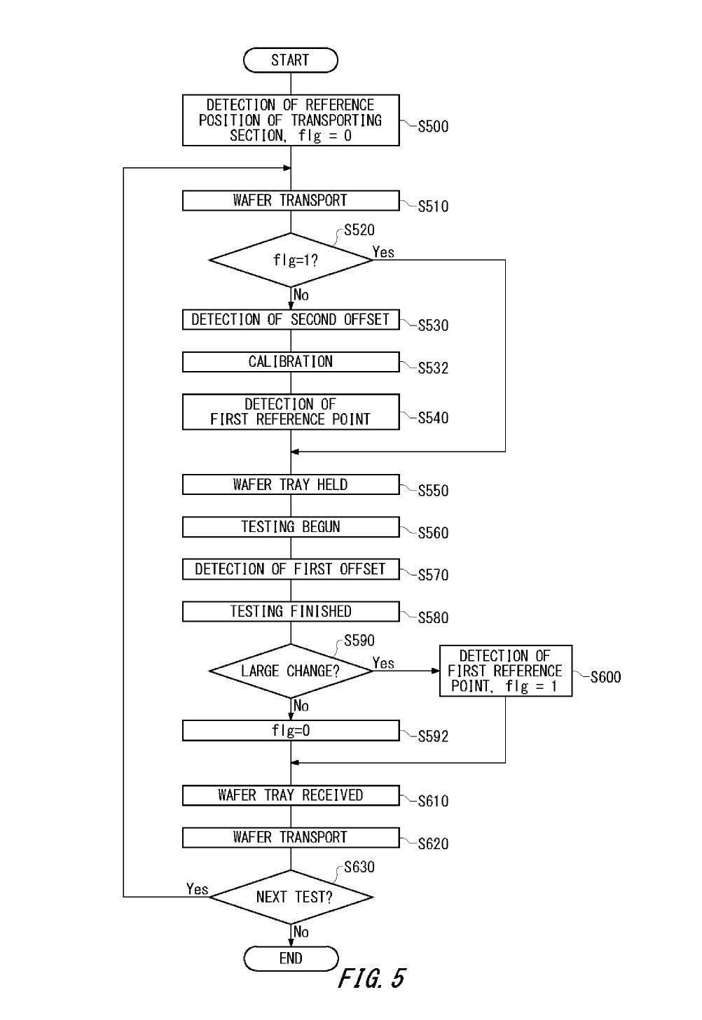

FIG. 5 shows a process flow of the correction apparatus 400 according to the present embodiment. FIGS. 4 and 6 to 10 are each a partial vertical cross-sectional view of the correction apparatus 400 at each stage of the correction process according to the present embodiment. The process flow of the present embodiment describes an example in which the transporting section 422 transports a semiconductor wafer 101a to a probe card 300a. The probe cards 300b, 300c, and 300d are respectively connected to semiconductor wafers 101b, 101c, and 101d, and the test sections 530b, 530c, and 530d may each test the corresponding device under test.

First, the reference position is detected on the transporting section 422 (S500). In the present embodiment, the second sensor 440 detects the second reference point 470 formed on the alignment stage 410 as the reference position on the transporting section 422. The correction control section 500 moves the transporting section 422 such that the second reference point 470 is positioned near the second sensor 440.

The correction control section 500 may move the transporting section 422 to a predetermined position. In this case, the storage section 510 may store the predetermined position at which the second reference point 470 is positioned near the second sensor 440, and the correction control section 500 may read the stored position and move the transporting section 422. The storage section 510 may store a plurality of predetermined positions corresponding to a plurality of the second sensors 440.

The second sensor 440 captures an image of the surface of the alignment stage 410 including the second reference point 470, and detects the second reference point 470 by performing image processing. Instead, the second sensor 440 may radiate laser light to scan the surface of the alignment stage 410, and detect the second reference point 470 by detecting scattered light from this laser light.

The correction control section 500 may set a fig value of 0 as an initial value. FIG. 4 is a partial vertical cross-sectional view of a stage at which the second sensor 440a of the present embodiment detects the second reference point 470.

Next, the semiconductor wafer 101a is transported into the correction apparatus 400 (S510). The transporting section 422 mounts the wafer tray 450a on the alignment stage 410, and the robot arm 116 transports the semiconductor wafer 101a to be mounted on the wafer tray 450a. For example, the transporting section 422 receives the wafer tray 450a held by the holding section 424a. In this case, the transporting section 422 moves to a predetermined position corresponding to the probe card 300a and receives the wafer tray 450a, and then the robot arm 116 transports the semiconductor wafer 101a.

Since the fig value is set to the initial value of 0, the process moves to the next step (S520). Next, the second sensor 440a detects the second offset (S530). Here, the correction control section 500 moves the transporting section 422 to the position at which the second reference point 470 was detected in step S500, and the second sensor 440a detects the reference position on the semiconductor wafer 101a. The correction control section 500 detects, as the second offset, the difference between the detected position of the second reference point 470 and the detected position of the reference point on the semiconductor wafer 101a.

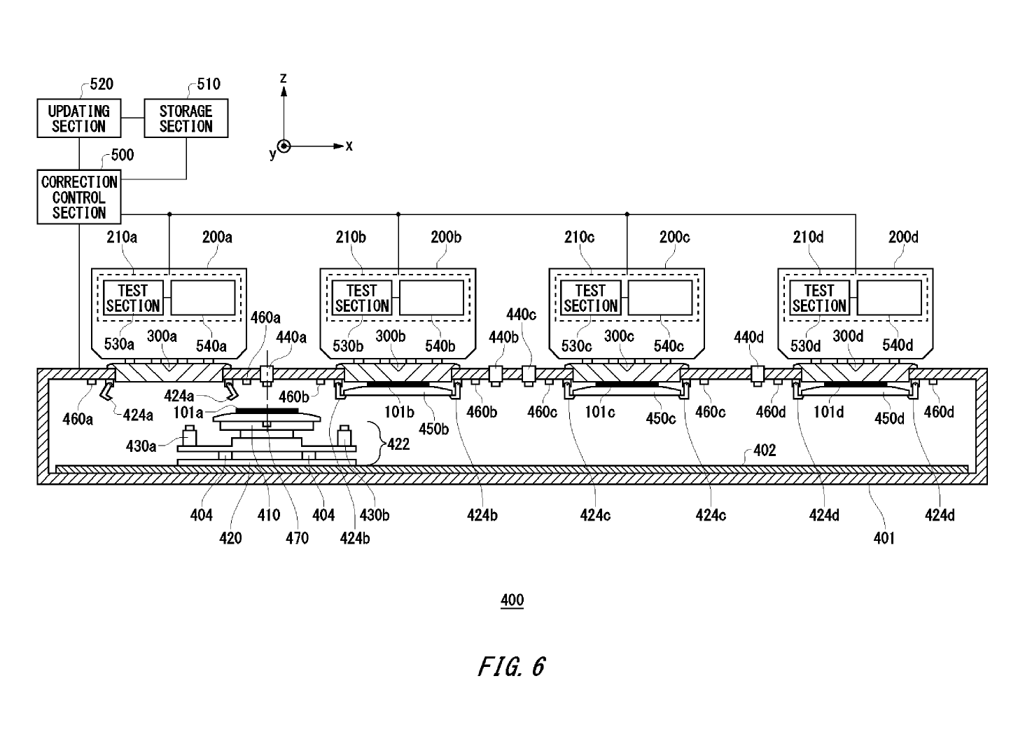

FIG. 6 is a partial vertical cross-sectional view of a stage at which the correction control section 500 according to the present embodiment detects the second offset. FIG. 6 shows an example in which the correction control section 500 uses the second sensor 440a to detect the second offset by detecting a predetermined reference point at substantially the center of the semiconductor wafer 101a.

For example, when the semiconductor wafer 101a is transported such that the center position of the semiconductor wafer 101a (i.e. the reference point position) matches the center position of the alignment stage 410 (i.e. the position of the second reference point 470), the correction control section 500 sets the second offset to be 0. More specifically, the correction control section 500 may define the second offset separately in the x-direction and the y-direction, and set each of these split offset amounts to 0.

Next, the correction control section 500 detects the first offset and performs a calibration (S532). For example, the correction control section 500 uses the first sensor 430a to detect the position of the second sensor 440a, and sets the first offset to be the difference between the detected positions of the first sensor 430a and the second reference point 470. Instead, the correction control section 500 may use the first sensor 430b to detect the position of the second sensor 440a, and set the first offset to be the difference between the detected positions of the first sensor 430b and the second reference point 470.

As another example, the correction control section 500 may use the second sensor 440 to detect the position of the first sensor 430a, and set the first offset to be the difference between the detected positions of the first sensor 430a and the second reference point 470. As yet another example, the correction control section 500 may use the second sensor 440a to detect the position of the first sensor 430b, and set the first offset to be the difference between the detected positions of the first sensor 430b and the second reference point 470. The correction control section 500 may move the transporting section 422 such that the first sensor 430a is positioned near the second sensor 440a, for example.

The correction control section 500 may move the transporting section 422 to a predetermined position. In this case, the storage section 510 may store the predetermined position at which the first sensor 430a is positioned near the second sensor 440a, and the correction control section 500 may read the stored position and move the transporting section 422. The storage section 510 may store a plurality of predetermined positions corresponding to a plurality of the second sensors 440.

As an example, the second sensor 440a may further include a light source section that outputs light, and the first sensor 430a may detect the light output from the second sensor 440a. In this case, the first sensor 430 may capture an image of the region including the second sensor 440a, and detect the position of the second sensor 440a through image processing or the like. Instead, the first sensor 430 may include a light receiving section that receives light, and detect the position of the second sensor 440a according to the intensity of light received by the light receiving section caused by light scanning or movement of the transporting section 422.

As another example, the first sensor 430a may further include a light source section that outputs light, and the second sensor 440a may detect the first offset by detecting the light output from the first sensor 430a. In this case, the second sensor 440 may capture an image of the transporting section 422 including the first sensor 430a, and detect the position of the first sensor 430a through image processing. As yet another example, the second sensor 440 may further include a light receiving section that receives light, and detect the position of the first sensor 430a according to the intensity of light received by the light receiving section caused by light scanning or movement of the transporting section 422.

The light source section of the first sensor 430 or second sensor 440 includes a light source such as an LED and an optical system such as a lens, and outputs substantially collimated light. Furthermore, the light source section may include a light source such a laser light source.

Instead, the correction control section 500 may detect the first offset based on the result of image capturing of one of the first sensor 430a and the second sensor 440a performed by the other. For example, the second sensor 440a may capture an image of the transporting section 422 including the first sensor 430a, and detect the first sensor 430a through image processing. Instead, the first sensor 430a may capture an image of the ceiling surface of the case 401 including the second sensor 440a, and detect the second sensor 440a through image processing.

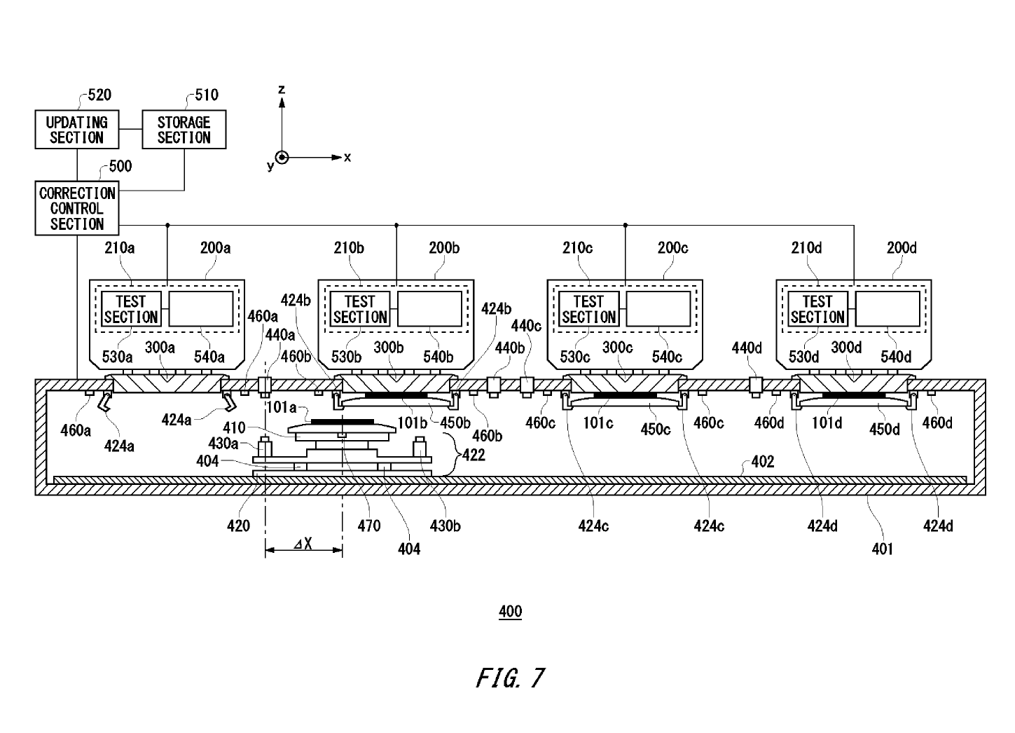

FIG. 7 is a partial vertical cross-sectional view of a stage at which the correction control section 500 according to the present invention detects the first offset and performs calibration. FIG. 7 shows an example in which the correction control section 500 detects the value ΔX of the first offset in the x-direction, based on the x-coordinate position of the first sensor 430a and the x-coordinate position of the second reference point 470. In addition, the correction control section 500 may detect the value ΔY of the first offset in the y-direction, based on the y-coordinate position of the first sensor 430a and the y-coordinate position of the second reference point 470.

The detection of the first offset in step S532 is the detection of the first offset performed immediately after transport of the semiconductor wafer 101a, and the correction control section 500 sets this first offset value to be the initial reference value. Therefore, step S532 in the present embodiment is referred to as calibration.

Next, the first sensor 430 detects the position of the first reference point 460 (S540). For example, the first sensors 430a and 430b respectively detect the corresponding first reference points 460a. The correction control section 500 moves the transporting section 422 such that the first sensors 430a and 430b are respectively positioned near the corresponding first reference points 460a.

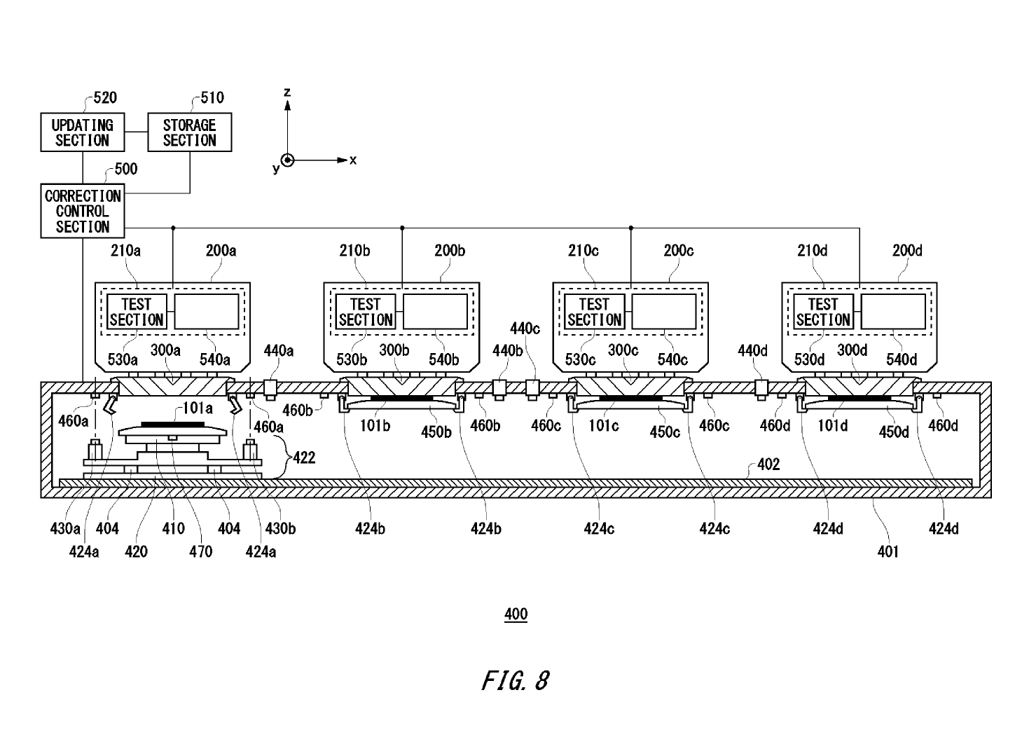

The correction control section 500 may move the transporting section 422 to a predetermined position. In this case, the storage section 510 may store the predetermined position at which the first sensor 430 is positioned near the first reference point 460, and the correction control section 500 may read the stored position and move the transporting section 422. The storage section 510 may store a plurality of predetermined positions corresponding to a plurality of the first reference points 460. FIG. 8 is a partial vertical cross-sectional view of a stage at which the first sensors 430a and 430b according to the present embodiment detect the corresponding first reference points 460a.

The correction control section 500 may correct the position of the transporting section 422 according to the values of the first offset and the second offset. The correction control section 500 can identify the relative position of the semiconductor wafer 101a on the transporting section 422 with respect to the second reference point 470 according to the second offset value, and can identify the relative position of the first sensor 430a with respect to the second reference point 470 according to the first offset value. In other words, the correction control section 500 can identify the relative position of the semiconductor wafer 101a with respect to the first sensor 430a, via the second reference point 470.

The relative position of the probe card 300a provided in the case 401 with respect to the first reference point 460a is already known. Accordingly, the correction control section 500 can identify the relative position of the semiconductor wafer 101 with respect to the probe card 300a by using the first sensor 430a to detect the position of the first reference point 460a.

Accordingly, the correction control section 500 can correct the position of the semiconductor wafer 101a such that the electrodes formed on the semiconductor wafer 101a are electrically connected to the probes formed on the probe card 300a. The correction control section 500 stores the correction amount by which the semiconductor wafer 101 was moved in the storage section 510, and when moving the transporting section 422 to the probe card 300a, may correct the relative position of the transporting section 422 with respect to the probe card 300a based on this correction amount.

Next, the correction control section 500 moves the alignment stage 410 vertically upward in a direction substantially parallel to the z-axis direction, and presses the semiconductor wafer 101a against the probe card 300a. As a result, the electrodes formed on the semiconductor wafer 101a are electrically connected to the probes formed on the probe card 300a.

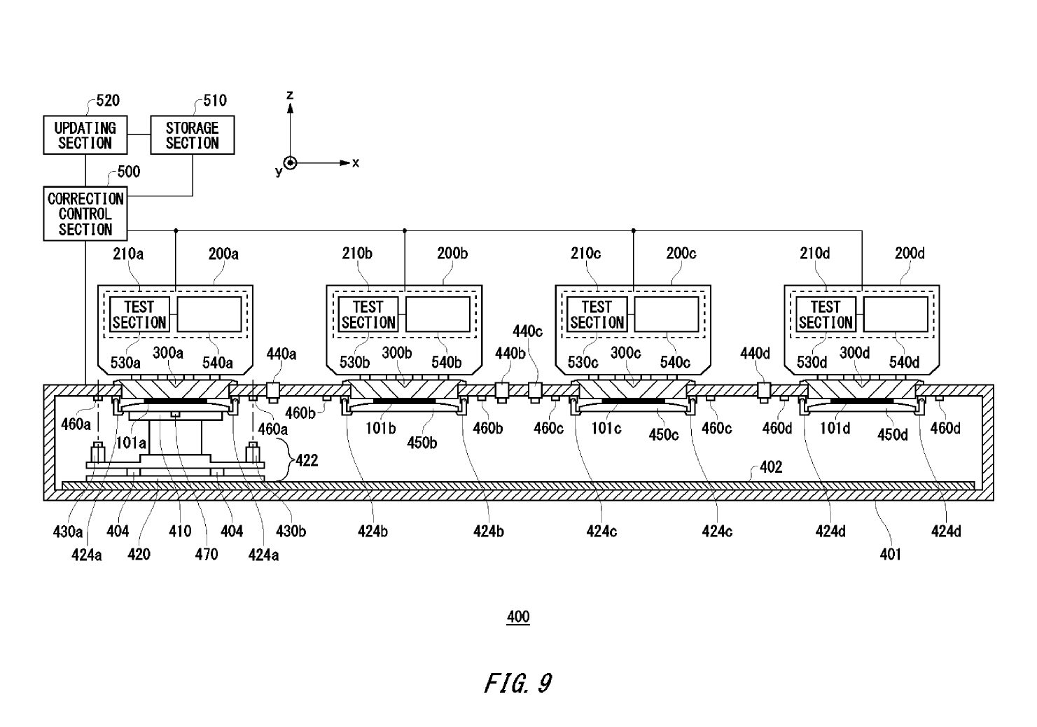

The holding section 424a holds the semiconductor wafer 101a and the wafer tray 450a, in a state where the electrodes formed on the semiconductor wafer 101a are electrically connected to the probes formed on the probe card 300a (S550). FIG. 9 is a partial vertical cross-sectional view of a stage at which the holding section 424a according to the present embodiment holds the semiconductor wafer 101a together with the wafer tray 450a.

Next, the test section 530 begins testing the devices under test formed on the semiconductor wafer 101a (S560). The test section 530 may start the testing in response to acquiring a timing signal that causes testing by the correction control section 500 to begin. Instead, the test section 530 may transmit a signal to the correction control section 500 inquiring as to whether testing can be begun, at a timing corresponding to a test program, and start testing upon receiving a response signal from the correction control section 500.

Next, the correction control section 500 detects the first offset (S570). In other words, the correction control section 500 detects the first offset while in a state where the semiconductor wafer 101a and the wafer tray 450a transported to the wafer station are connected to the wafer station and the transporting section 422 has yet to receive the next semiconductor wafer 101. The detection of the first offset is performed in the same manner as described in step S532, and therefore no further description is provided here. The correction control section 500 detects the first offset in response to receiving a start signal from the transmitting section 540.

Before the testing begun by the test section 530 is completed, the transmitting section 540 transmits to the correction control section 500 a start signal that causes the correction control section 500 to begin detecting the first offset. The transmitting section 540 may transmit the start signal according to the progression state of the test program executed by the test section 530, or may instead transmit the start signal in response to the passage of a predetermined time from when the testing started.

Preferably, the transmitting section 540 transmits the start signal such that the detection of the first offset to be performed next is finished before the time when the test section 530 ends testing. More preferably, the transmitting section 540 transmits the start signal such that the detection of the first offset to be performed next is finished immediately before the test section 530 finishes testing. The transmitting section 540 may transmit the start signal such that the detection of the first offset to be performed next is finished at the same time that the test section 530 finishes testing.

In this way, the transmitting section 540 causes detection of the first offset to begin such that the detection of the first offset is finished before the test section 530 finishes testing, and therefore the correction control section 500 can detect the first offset while the test section 530 performs the testing. Accordingly, the correction control section 500 can prevent an increase in the testing time, even when the first offset is detected in order to monitor the effect of temperature change and/or change over time during testing.

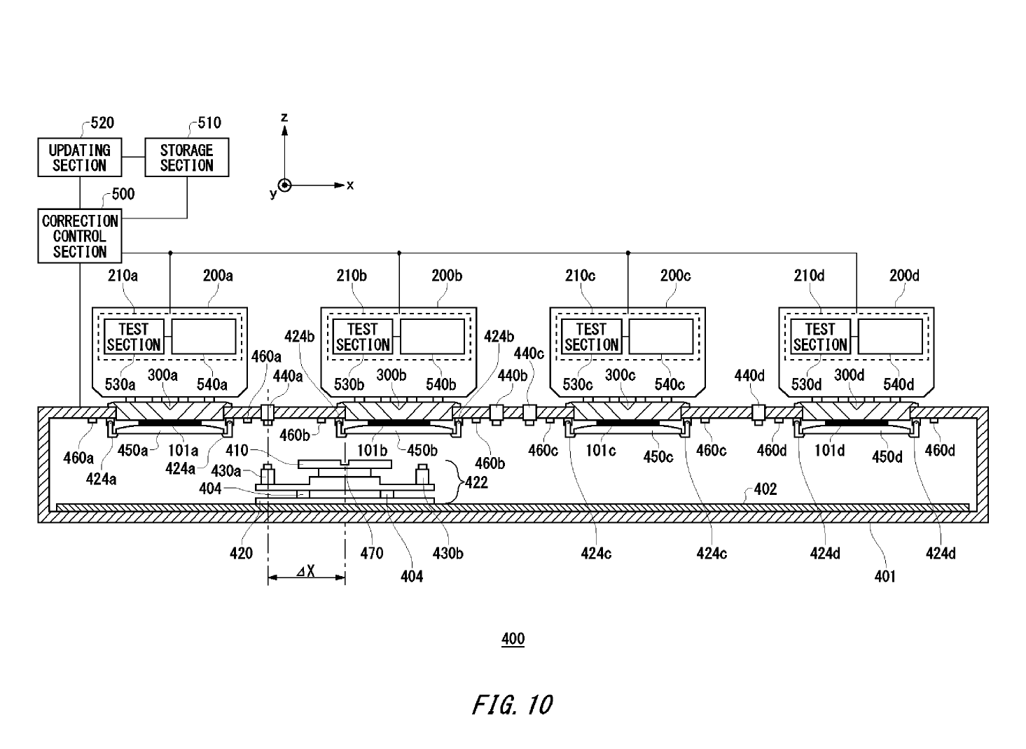

If the detection of the first offset is finished immediately before the test section 530 finishes testing, the correction control section 500 can monitor the effect of temperature change and/or change over time immediately after the testing. FIG. 10 is a partial vertical cross-sectional view of a stage at which the correction control section 500 according to the present embodiment detects the first offset during testing of the semiconductor wafer 101a.

Next, the testing by the test section 530 is finished (S580). Preferably, the test section 530 finishes testing after or at substantially the same time as the detection of the first offset is finished.

The correction control section 500 then compares the detection results of step S532 to the detection results of the first offset detected at step S570, and judges whether the change is large (S590). The correction control section 500 judges whether the change is large based on whether the change of the first offset exceeds a reference change amount. This reference change amount may be set in advance, according to the acceptable error range for the relative positions of the semiconductor wafer 101 and the probe card 300a.

The acceptable error range is a range with which, if the error in the relative positions of the semiconductor wafer 101 and the probe card 300a is within this range, then the electrodes formed on the semiconductor wafer 101a and the probes formed on the probe card 300a will be electrically connected to each other when the semiconductor wafer 101a is pressed against the probe card 300a. The acceptable error range may be set in advance according to the pitch or surface area of the electrodes or the pitch or size (dedicated surface area in the XY-plane) of the probes, for example. The correction control section 500 determines whether the temperature change and/or change over time caused by the testing affects the electrical connection between the semiconductor wafer 101 and the probe card 300a, based on the fluctuation of the first offset.

When the change of the first offset is greater than or equal to the reference change amount, the correction control section 500 detects the position of the first reference point 460 using the first sensor 430 (S600), and then receives the wafer tray 450a (S610). In other words, since the testing has caused fluctuation in the first offset, the correction control section 500 detects the first reference point 460 before receiving the wafer tray 450a in order to reliably receive the wafer tray 450a.

The correction control section 500 may set the flg value to 1 in response to the change of the first offset being large, for example. Here, the detection of the first reference point 460 is substantially the same as the operation performed at step S540, and therefore further description is omitted.

On the other hand, when the change of the first offset is less than or equal to the reference change amount, the correction control section 500 omits the detection of the position of the first reference point 460, and the wafer tray 450a is received (S610). The correction control section 500 moves the transporting section 422 to the position where the wafer tray 450 was held at step S550, and causes the transporting section 422 to receive the wafer tray 450a. In other words, since there was no fluctuation in the first offset when testing was performed, even when the detection of the position of the first reference point 460 by the correction control section 500 is omitted, the transporting section 422 can move to the position where the wafer tray 450a is held with good reproducibility, and can receive the wafer tray 450a.

The correction control section 500 sets the flg value to 0, in response to the change of the first offset being small. Furthermore, the operation of receiving the wafer tray 450a is substantially the same as the reverse of the operation performed in step S550, and therefore further description of this operation is omitted.

Next, the semiconductor wafer 101a is transported outside of the correction apparatus 400 (S620). For example, the robot arm 116 transports the semiconductor wafer 101a mounted on the wafer tray 450a from the correction apparatus 400 to the FOUP 150.

If there is a semiconductor wafer 101a that is to be electrically connected to the probe card 300a and tested in the FOUP 150, the test apparatus 100 performs the next test (S630). In this case, the process moves to step S510 and the semiconductor wafer 101a is transported into the correction apparatus 400. If the flg value is set to 0, the test apparatus 100 repeats the operations from step S510 to step S630 described above.

On the other hand, if the flg value is set to 1, the correction control section 500 omits the detection of the first offset, the second offset, and the first reference point. In other words, when there is no fluctuation in the first offset when the previous testing is finished, the current semiconductor wafer 101a to be tested is mounted on the transporting section 422 at the position where the semiconductor wafer semiconductor wafer transported during the previous testing was held, and the semiconductor wafer 101a of the current test is held on the holding section 424 together with the wafer tray 450a (S550).

In other words, when there is no fluctuation in the first offset due to the testing, the detection of the first offset, the second offset, and the first reference point is omitted, and the transporting section 422 can move to the position where the previous wafer tray 450a was held with good reproducibility, and can hold the wafer tray 450a. If the change of the first offset detected by the correction control section 500 is less than or equal to the reference change amount, the correction apparatus 400 omits the calibration according to the detection of the first offset, the detection of the second offset using the second sensor 440, and/or the detection of the first reference point using the first sensor 430.

The test apparatus 100 repeats the process from step S510 to step S630, until there are no more semiconductor wafers 101 to be tested. In this way, the test apparatus 100 corrects misalignment between the semiconductor wafer 101 and the probe card 300 when the change of the first offset is greater than the reference, and omits the calibration, the detection of the second offset, and/or the detection of the first reference point when the change of the first offset is less than the reference. Therefore, the test apparatus 100 can correct the misalignment between the semiconductor wafer 101 and the probe card 300 while preventing an increase in the testing time.

The present embodiment describes an example in which, when the first offset is less than the reference change amount, the correction apparatus 400 omits the detection of the second offset and the like. Instead, the correction apparatus 400 may omit the calibration according to detection of the first offset, the detection of the second offset using the second sensor 440, and/or the detection of the first reference point using the first sensor 430 when the change of the first offset detected by the correction control section 500 is less than or equal to the reference change amount in series over at least a reference number of measurements.

In this case, the correction control section 500 may include a counter that counts the number of times that the change of the first offset is less than or equal to the reference change amount. The correction control section 500 may increment the counter when the change of the first offset is less than or equal to the reference change amount at step S590, and clear the count when the change of the first offset is greater than the reference change amount. The correction control section 500 branches to either step S592 or step S600, according to whether the count of the counter is greater than the predetermined reference number of measurements.

While the embodiments of the present invention has have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. A correction apparatus that corrects misalignment of a transported object at a transport destination, comprising:
a first sensor that is secured to a transporting section transporting the object; and
a correction control section that detects a first offset between the transporting section and the first sensor, while the object transported to the transport destination is positioned at the transport destination, by using the first sensor to detect a position of a first reference point provided to correspond to a target position at the transport destination.

2. The correction apparatus according to claim 1, further comprising a second sensor that is secured to the first reference point, wherein
the object is mounted on one surface of the transporting section from outside, and
the correction control section uses the second sensor to detect a second offset between the object and a position of a second reference point provided on the one surface and secured to the transporting section.

3. The correction apparatus according to claim 2, wherein
with one object transported to the transport destination being connected to the transport destination and with a following object not yet received by the transporting section, the correction control section detects the first offset.

4. The correction apparatus according to claim 2, wherein
the correction control section detects the second offset by detecting a position of the second reference point and a predetermined reference point of the object.

5. The correction apparatus according to claim 2, wherein
the correction control section corrects the misalignment at the transport destination based on a result of a detection of a position of the first reference point using the first sensor, in response to change of the first offset exceeding a reference change amount.

6. The correction apparatus according to claim 5, wherein
the correction control section omits detection of the second offset when the detected change of the first offset is less than or equal to the reference change amount in series for greater than or equal to a reference number of times.

7. The correction apparatus according to claim 5, wherein
the correction control section omits detection of the first reference point when the detected change of the first offset is less than or equal to the reference change amount in series for greater than or equal to a reference number of times.

8. The correction apparatus according to claim 2, comprising:
a storage section that stores the first offset detected by the correction control section; and
an updating section that, when change of the first offset exceeds a reference change amount, updates the first offset stored in the storage section to be the first offset detected by the correction control section.

9. The correction apparatus according to claim 2, wherein
the first sensor includes a first image capturing section and the second sensor includes a second image capturing section, and
the correction control section detects the first offset based on a result of image capturing of one of the first image capturing section and the second image capturing section by the other of the first image capturing section and the second image capturing section.

10. The correction apparatus according to claim 2, wherein
the second sensor further includes a light source section that outputs light, and
the correction control section detects the first offset according to reception of light output from the second sensor by the first sensor.

11. The correction apparatus according to claim 2, wherein
the first sensor further includes a light source section that outputs light, and
the correction control section detects the first offset according to reception of light output from the first sensor by the second sensor.

12. The correction apparatus according to claim 2, wherein
the object includes a semiconductor wafer having a plurality of electrodes formed thereon, and
the second sensor is a wafer camera that captures an image of the second reference point and a predetermined reference point on the semiconductor wafer.

13. The correction apparatus according to claim 1, wherein
the transporting section transports a plurality of the objects respectively to a plurality of the transport destinations.

14. A probe apparatus comprising the correction apparatus according to claim 1, wherein
the object is a semiconductor wafer on which a plurality of electrodes are formed and a wafer tray on which the semiconductor wafer is mounted,
the transport destination is a wafer station that includes:
a holding section that holds the wafer tray; and
a probe card that is electrically connected to the electrodes formed on the semiconductor wafer, and
a first offset between the transporting section and the first sensor is detected while the wafer tray is held by the holding section.

15. The probe apparatus according to claim 14, comprising a plurality of the wafer stations, wherein
the first sensor includes a plurality of probe cameras that detect a position of each first reference point, and a plurality of first reference points being provided to each of a plurality of the probe cards.

16. A test apparatus that tests a plurality of devices under test formed on a semiconductor wafer, comprising:
a test section that tests the devices under test by exchanging electrical signals with the devices under test; and
the probe apparatus of claim 14 that is electrically connected to electrodes of each of the devices under test.

17. The test apparatus according to claim 16, further comprising a transmitting section that is connected to the test section and transmits a start signal causing the correction control section to begin detecting the first offset, wherein
the transmitting section transmits the start signal before testing of one or more of the test devices formed on one semiconductor wafer is finished.
